(19) United States
(12) Patent Application Publication
(10) Pub. No.: US 2020/0327310 A1
(43) Pub. Date: Oct. 15, 2020

(54) METHOD AND APPARATUS FOR FACIAL VERIFICATION

(71) Applicant: Francis R. Palmer, III, Beverly Hills, CA (US)

(72) Inventor: Francis R. Palmer, III, Beverly Hills, CA (US)

(21) Appl. No.: 16/846,099

(22) Filed: Apr. 10, 2020

Related U.S. Application Data
(60) Provisional application No. 62/832,247, filed on Apr. 10, 2019.

(51) Int. Cl. G06K 9/00; G06F 21/32

(52) U.S. Cl. CPC G06K 9/00288; G06F 21/32; G06F 2221/2133; G06F 2221/2103; G06K 9/00906

(57) ABSTRACT

The system provides a method and apparatus for facial verification. Instead of determining if an image can be found in a database of multiple possible matches, the present system uses facial verification to verify that the image represents one person who is the person the individual is claiming to represent. For example, when used as part of an authentication process, the system will generate information from a Challenge Image and determine if the image is that of an authorized user. This may be the primary protection system or be part of a multifactor authentication process. The system uses advanced comparative analysis for user identification and identity assurance. The system uses a procedure that reduces false positives, substantially eliminates the twin problem, and is not susceptible to the use of masks or other image spoofing techniques.

This patent application claims priority to U.S. Provisional Patent Application Ser. No. 62/832,247 filed on Apr. 10, 2019, which is incorporated by reference herein in its entirety.

### BACKGROUND OF THE SYSTEM

There has been increased use of, and awareness of, facial recognition for public, private, and governmental use. Many smart phones use facial recognition as a substitute for, of supplement to, a password. Companies such as Clear use facial recognition for access at travel points including airports. Many governments use facial recognition to aid in capturing criminal suspects, identifying unapproved visitors at borders, and tracking terrorists. Facial recognition uses some form of image capture, such as a still image or a video frame, and applies facial recognition algorithms to determine the identity of the person in the image. This often begins with identifying so called “anchor” points on the face, such as eyes, nose, mouth, and the like, and making a series of measurements from the anchor points to generate a reference of the face in the image. The reference is then normalized and compared to stored images to determine if there is a match.

A disadvantage of present facial recognition system is that the accuracy does not meet the strictest standards for personal user customer data or identity security or for use by the justice system. The possibility of false positives (mistakenly identifying the wrong person) remains unacceptably high. Another disadvantage is the length of time required to perform facial recognition. In addition, experiments have revealed the so called “identical twin” problem of mistaken identity of twins, as well as the use of three dimensional or two-dimensional masks or image representations to fool a facial recognition system. One recent National Institute of Standards and Technology (NIST) report testing the most accurate 127 facial recognition systems determined that none of the tested facial recognition systems were capable of distinguishing between twins of the same gender, let alone identical twins.

### SUMMARY

The system provides a method and apparatus for facial verification. Instead of facial recognition which is used to determine if an image can be found in a database of multiple possible matches of known identities, the present system uses facial verification to verify that the image represents one person, i.e. the person that particular individual is claiming to represent when seeking access to secure data, web sites, locations or performing any form of user authentication for identity assurance purposes. For example, when used as part of an authentication process, the system will generate information from a Challenge Image and determine if the image is that of an individual claiming to be or to represent an authorized user. This may be the primary protection system for an enterprise, or it may be part of a multifactor authentication process. The facial verification system might be used as a stand-alone application, mobile application or web based. The system may also be incorporated as an application Programming Interface (API), an extension, add-on, module and the like, to an existing program, browser-based system, cloud-based system, mobile application, and the like. The system uses an advanced system of analysis for user identification and identity assurance. The system uses a procedure that reduces false positives, substantially eliminates the twin problem, and incorporates a liveness detection component to eliminate spoofing through the use of masks or reproduced images either printed or otherwise digitally presented.

### BRIEF DESCRIPTION OF THE DRAWINGS

FIG. 1 is a flow diagram illustrating setup of an account in an embodiment of the system.

FIG. 2 is a flow diagram illustrating facial verification in an embodiment of the system.

FIG. 3 is a flow diagram illustrating the capture of a control image in an embodiment of the system.

FIG. 4 is a flow diagram illustrating the capture of a challenge image in an embodiment of the system.

FIG. 5 illustrates a third-party account utilizing the identity verification in an embodiment of the system.

FIG. 6 illustrates an example computer system for implementing the system.

### DETAILED DESCRIPTION OF THE SYSTEM

The system provides a method and apparatus for highly secure and accurate user verification using facial identification techniques. The system is highly accurate, exceeding current standards and proposed standards for many privacy protocols. The system can be used to provide access to a locked mobile device, act as a key for blockchain data, access to online user accounts, secure locations, user authentication processes, identity protection through identity assurance, accurate identification in the criminal justice system, “deep fake” defense, securing and assuring only the user and any intended recipient may access and view/read various methods of communication including but not limited to SMS and e-mail messages, securing and protecting data access, check-out and point-of-sale (POS) locations, and the like.

Currently user authentication (UA) is accomplished principally with the use of passwords. To improve security, many sign-on procedures require multi-factor authentication (MFA) which requires two or more sign in and authentication steps to accomplish. Often, MFA involves a password and a second code word and/or number to a location believed to be in the possession of the authorized user, such as an email account, mobile phone text message account, physical dongle, biometrics (e.g. fingerprint, iris scan, and the like). Users prefer a single sign-on (SSO) method when possible, but do not want to lose the increased security of MFA techniques.

The demand for more ease of use of the multiple accounts and devices that users employ has been the Single Sign-on (also known as Social Sign-on) or “SSO”. SSO provides access control for multiple related, but independent software systems. A single username or ID and a single password is used to access to multiple devices, systems, or accounts. Such a single sign on approach is risky unless there is a very high level of identity assurance (i.e. a user is actually who they claim to be).

Regardless of which type of access is used, the need for highly accurate UA and identity assurance is imperative. When system access is attempted by an account owner, the system must know for certain that the person requesting access is in fact the account owner. (Please note that “account owner” can encompass more than one person and may refer to anyone who is an authorized user entitled to some level of access of a system).

There are a number of biometric approaches to provide some kind of identity assurance in whole or in part. These include voice, fingerprint, facial recognition, hand/palm print, iris, and/or vein recognition. Most of these techniques do not provide adequate security or a high enough level of identity assurance for practical use (e.g. voice and fingerprint). Such techniques suffer from the possibility of deceptive techniques such as voice recordings and fingerprint duplication. Other techniques, such as iris and vein recognition, suffer from low acceptance rates and a lack of implemented systems. Many of these systems have proven to be vulnerable to hacking and spoofing attacks.

Facial recognition has a middle of the pack accuracy rate, but a high acceptance rate, with nearly all smartphones and other mobile devices coming equipped with some form of facial recognition. Facial recognition is the system of comparing a captured image from a still or video feed. That image is then compared against a database often containing millions of images with “known” identities. This process can be defined as determining “who am I”, or what is “the identity” of the unknown image. This is a time-consuming process with an outcome that is determined by many factors including: the comparative “database” used, the quality of the “captured image” and the “comparative” quantitative identification process used in the facial recognition attempt.

If the database does not include an image of the individual whose image is being evaluated, the system cannot yield a positive or useful match and outcome. The false positive rate or the rate where an unknown image is falsely identified can vary significantly based upon these factors.

For these reasons, the present system uses facial verification that dramatically improves the accuracy (lowering the false positive rate) that is real-time capable, uses less computing time and resources, and therefore is less expensive to perform. Facial verification, as outlined here, compares images on a 1 to 1 basis using a “Control Image” of a known user and identity with a captured “challenge” image for the purposes of determining is the “user” in fact who he/she is claiming to represent. This process can be defined as a determination of the users case of being “Me or not Me”.

The user initially signs into the system and registers with the system by capturing a “control” image after entering some basic identifying information including, but not limited to: name, social security number, passport number, cell phone number, age and gender. The Control Image is stored with date/time/GPS stamp and the user is assigned a “User ID” and unique “ID Number”. In any subsequent request, initiated by the user through an in person or remote access device for the purpose of user authentication or identity assurance, the user enters their unique User ID, unique ID Number and captures a “challenge image” for facial verification using our advanced System Analysis.

The present system provides a facial verification system that has an accuracy that is many times the current required standards, as well as higher than anticipated standards in the coming years. Some current facial recognition schemes, such as MS Hello Face, has an accuracy of only 1 in 100,000. FaceID and MegviFace have accuracy of 1 in one million. The present system offers a predicted accuracy of one in 10 billion, meaning that the odds or probability of making a false positive match to any other image than the intended user for purposes of identity verification is predicted to be one in 10 billion using a Level 6 System Analysis. The system has the ability to achieve even lower false positive rates using increasing levels of facial verification. The system accuracy approaches planetary scale accuracy which meets and or exceeds the mandated governmental security requirements for user authentication and identity assurance such as those set forth in the GDPR or General Data Protection Regulations and SCA or Strong Consumer Authentication adopted by the European Union.

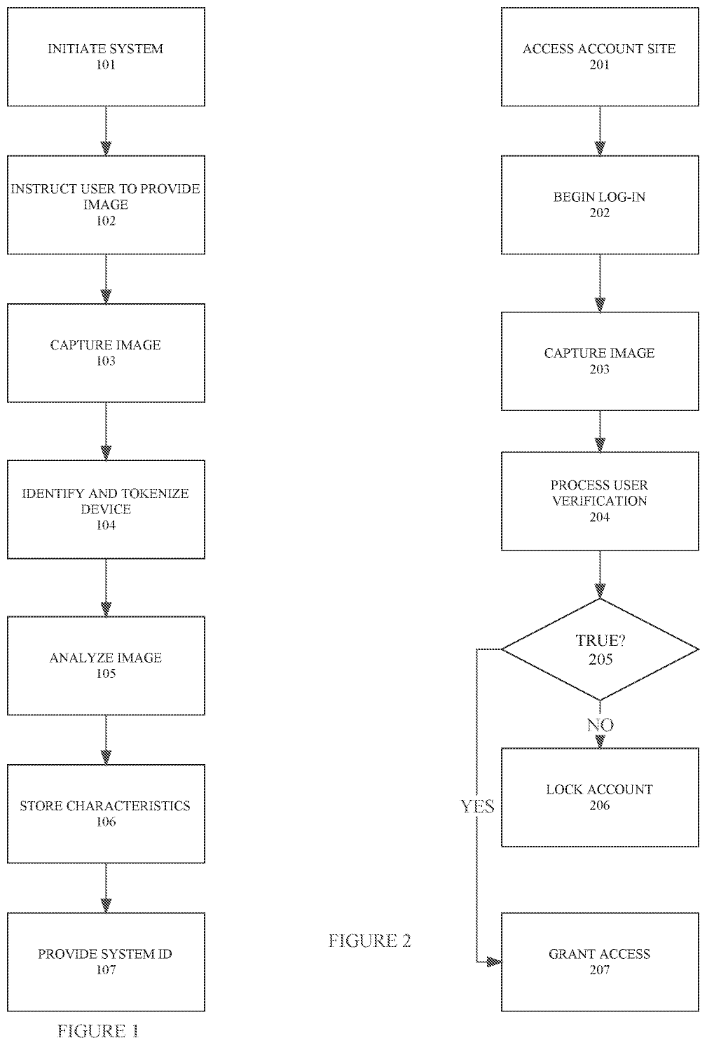

FIG. 1 is a flow diagram illustrating the creation of a facial verification account in an embodiment of the system. This can be used as a stand-alone facial verification system or may be incorporated into an existing system for purposes of granting user access through user authentication and identity assurance. At step 101 the user initializes the system and chooses account creation. The system may be implemented on a processing system such as a desktop or laptop computer, tablet, smartphone, and the like. The processing system should have an integrated camera or be coupled electronically to a camera or other image capture device. This connection can be wired or wireless.

At step 102 the system instructs the user to take a picture with the system to generate a Control Image. In addition to the image, the system captures some basic verifiable information to establish this is indeed the person who is attempting to set up the account, including government issued ID information, credit information, passport, driver's license, and the like, to prevent abuse of the system by imposters. The image is then GPS/date/time stamped which can be useful in defense of “deep fake” image/video manipulation attacks. All information including images and all routes of communication is encrypted using at or above high standard level of encryption. At step 103 the system captures the image.

At step 104 the system also identifies the device on which the user is capturing the image. In one embodiment, the system places a token on the device and begins a counter. The system can require that this device be used in the future for ID verification and can check the token and the count to confirm that the user is using a validated and verified device when attempting verification. This provides an additional level of security to the system.

At step 105 the system analyses and processes the image to identify unique characteristics. At step 106 the system stores the unique characteristics and associates them with the captured image and that image now becomes a Control Image of the user. The Control Image is stored along with the GPS date/time stamp as well as the analysis in an encrypted environment along with a generated user ID, user ID number and elected mode of contact (cell number and/or e-mail). Contact is used as an early security alert in the event of a failed verification attempt which may represent a security risk or attempt at identity theft. The contact may also be used to initiate an additional level of user authentication through the generation of a specific “one-time” use verification code as part of the verification process before the user can present a challenge image to be verified. When used in this manner the system can adopt all three major areas of user authentication as spelled out and required by the SCA (strong consumer authentication) mandates set to take effect in the EU in September of 2019.

At step 107 the user is provided with the System User ID that is a unique ID Number associated with the captured image. The user can then use the combination of the captured image and the System ID as account control for any private account of the user.

In one embodiment, the system is engaged for any password protected account that the user authorizes. The user can add the system verification process as an extra step prior to providing access to the account, while still using the authentication scheme of the account. In this way, the system can act as one factor in a multifactor identification process. In one embodiment, the system entirely replaces the authentication scheme of the account and when a user attempts a login process, the account redirects the authentication process to the system for verification.

FIG. 2 is a flow diagram illustrating the operation of the system in user authorization in an embodiment of the system. At step 201 the user accesses an account site. At step 202 the user begins the log-in process via the account system. The account system will direct the user to the system server for ID verification. The user will enter the user's SystemID at this point to trigger engagement with the verification process of the system. In one embodiment, the user is then sent a one-time verification code via SMS to the cell phone on record as a further initial security method. At step 203 the system is engaged (either natively or through redirect to the system site) and the system captures an image of the user to create a Challenge Image.

At step 204 the system compares the Challenge Image to the Control Image of the user associated with the System ID that has been entered in previous steps. At decision block 205 it is determined if the Challenge Image matches the Control Image. If not, the system locks the account after some set number of failed verification attempts (e.g. one, two or some other number of failed attempts), prevents access at step 206 while sending a failed verification notice to the registered user through the accepted method of communication, like an SMS which may include referral to the appropriate customer service contact number should the user wish to seek an override as a means of gaining access. If the Challenge Image and the Control Image match at decision block 205, the system proceeds to step 207 and permits access to the account.

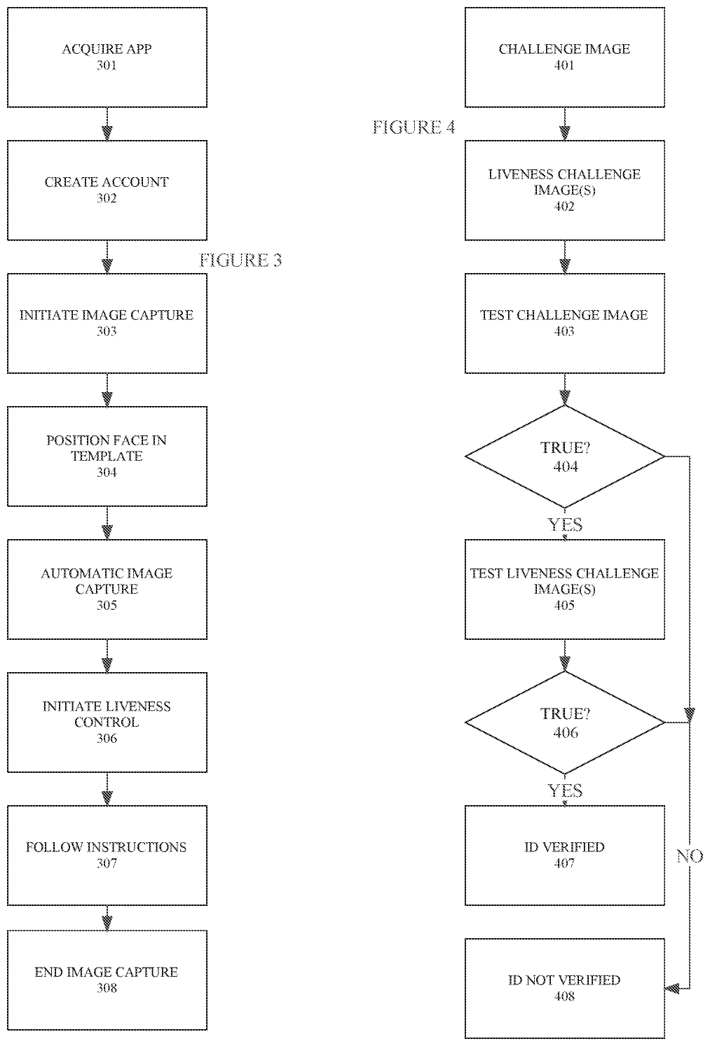

FIG. 3 is a flow diagram illustrating image capture of a Control Image in an embodiment of the system. At step 301 the user acquires an app to download on a device of the user. The device may be a mobile phone, tablet, laptop, desktop, and/or any processing device with integrated or attached image capture capability. Once installed, the system app will tokenize the device and add a counter. The counter is used as additional security and to provide an additional tool of identification of the user.

At step 302 the user creates an account on the system. The name that the user chooses for the account must pass an “initial verification process” where the system checks that name and image against passport photos, drives license photos, SSN, mailing address, e-mail user accounts and any other number of accepted ways of initially verifying the user is indeed the person who is attempting to open the account. The “initial verification” takes some time and effort and is done to prevent misrepresentation and identity theft. Please note that in one embodiment of the process, the “initial verification process” could be done in one embodiment using specific unique verifying characteristic such as a DNA sequence, cardiac vibration or some other highly specific individual identifying factor that would make the “initial verification process” quicker and reliable.

At step 303 the user initiates the image capture feature of the app. At this point the app takes over the device image capture device (the user may need to authorize permission for this the first time). At step 304 the system presents a template on the device display and instructs the user to position their face within the bounds of the template. The user may need to move the device closer or further away, up or down, fix pitch or yaw and tilt, and manipulate the device to fit within the template. In one embodiment, the user is instructed to correct the plane of the device to make a head-on shot, and the system automatically controls the zoom of the camera to make the user's face fit within the template.

At step 305, the system automatically captures the image when the user's face is in the correct position and orientation. There is no need for the user to activate the shutter or image capture feature. This automatic image capture ensures a high-quality image that can be used as the Control Image in the system. Current cameras have high mega-pixel count cameras so that rich information can be captured with the image, including detailed color and skin information, as well as highly accurate relative, quantitative, and qualitative position information regarding certain facial features.

At step 306 the system also implements a procedure to provide liveness detection for ID verification. The system will instruct the user at step 307 to make certain facial expressions and movements (e.g. smile, head shake, frown, eye close, nod, and the like). There may be ten different expressions and movements that the system will request, although any number may be used. As the movements and expressions are performed by the user, the system will capture images (e.g. video, multi-photo sequence, and the like) for use in authorization procedures and stored as Liveness Control Images. At step 308 the image capture process is completed.

FIG. 4 is a flow diagram illustrating ID verification in an embodiment of the system. At step 401 the user's device captures a challenge image. As with the original Control Image, the system prompts the user to orient their face in a certain way and the system takes over the camera function to determine when to capture the image at the correct time. In addition, the system, via the device, will instruct the user to perform one or more liveness challenge images. This may be all or a subset of the Liveness Control Images. The result is one or more Liveness Challenge Images that can be compared to the Liveness Control Images to determine if the requesting person is wearing a mask or not.

At step 403 the system tests the Challenge Image against the Control Image. In one embodiment, the system uses pixel data and/or curvature data, volume data, boundary data and the like from an image to characterize an image for comparison purposes. In one embodiment, pixel data can refer to pixel density, pixel intensity, pixel gradient and the like. The data used is referred to herein as the comparison data. In one embodiment, the image is divided into grids and the comparison data is generated for each grid. The comparison data for each grid of the Challenge Image is compared to the value in the corresponding grid in the Control Image. The system requires a certain level of matching in each grid as well as a minimum number of matching grids before a facial verification is concluded. The technique uses a unique combination of specific areas of the face that are measured and compared in part or portion thereof or in whole and in one embodiment, the entire area of the face is measured and compared. The various number of these areas measured in portion or total thereof constitute the associated level of System Analysis performed. Increasing the area or level of System Analysis results in a decrease in the false positive rate associated with the facial verification process. In theory and as a practical conclusion there is no limit to the number of areas that can be compared using the System Analysis process. We believe that a level 6, with a predicted false positive rate of 1 in 10 billion, offers the level of accuracy required by newly passed GDPR (General Data Protection Regulations) and SCA (Strong Customer Authentication) requirements for secure user authentication and identity assurance methods.

The evaluation may use pattern, shape, contour, density, based upon pixel density, pixel intensity, pixel distribution or total amount/number of pixels or similar point by point measurement (defined as three dimensional points in space typically referred to in an image multidimensional matrix or matrices as x, y and z coordinates) measurements in white light (RGB and Greyscale), infrared, ultraviolet and any other spectrum of light, or medium creating a similar shape, contour or point by point measurement through any method of displacement using radio frequency, sound waves or distortions or displacement in sound, molecules, or any medium for the purpose of generating parts of an image, image representation or total image of the face or parts of the face.

At step 404 it is determined if the ID test is true (e.g. the Challenge Image matched the Control Image). If so, the system proceeds to step 405. If not, the system proceeds to step 408 and indicates that the user ID is not authenticated or verified.

At step 405 the system tests the Liveness Challenge Images against the Liveness Control Images. The techniques described above can be used to compare these images as well. The system may select certain frames from the Liveness Challenge Images to compare against the Liveness Control Images. In one embodiment, the system compares the video snippet of a Liveness Challenge Image against the video snippet of the Liveness Control Image. At step 406 it is determined if the Liveness test is true. If so, the ID of the user is verified, and the account can be accessed. If not, the system proceeds to step 408 and the user ID is not authenticated or verified. In one embodiment, the system may use only the Liveness Challenge Images to test ID. In one embodiment, the system may use only the Challenge Image to test ID.

In addition, the system will require the user to enter the User ID and User Identification number as an additional ID test. Also, the system will check the user device for the tokenization and the count number to confirm the ID of the user.

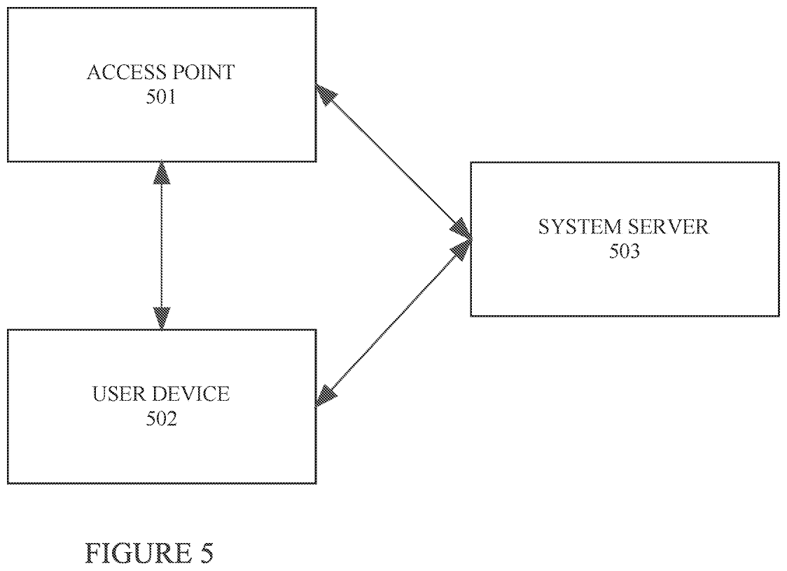

FIG. 5 illustrates a third-party account utilizing the identity verification in an embodiment of the system. The Access Point 501 is the account, location, and the like that the user wishes to access. The Access Point 501 may be a financial service and/or payment system, casino gaming, retail POS, airline or other carrier ticket purchase, TSA checkpoint, government security, healthcare and/or health insurance checkpoint, AI/Human interaction, data privacy and security, law enforcement/criminal justice, insurance, digital gaming, and the like. The system may be used as part of Know-Your-Customer (KYC) determination, anti-money laundering, anti-fraud, customer onboarding, recurring customer identity verification, GDPR/SCA compliance, blockchain access, digital identity, identity verification solutions, and the like. The system may be used to verify antibody testing results for an individual.

The Access Point 501 has agreed to accept the system for ID verification. The Access Point may have some login procedure in addition to the system ID verification. The user device 502 then invokes the system to confirm user ID as noted above. The user device 502 communicates with the system server 503 to perform the ID check. The system server communicates with the Access Point 501 and the user device 502 and can communicate success or failure of the ID check to the user and the access point.

Example Computer System

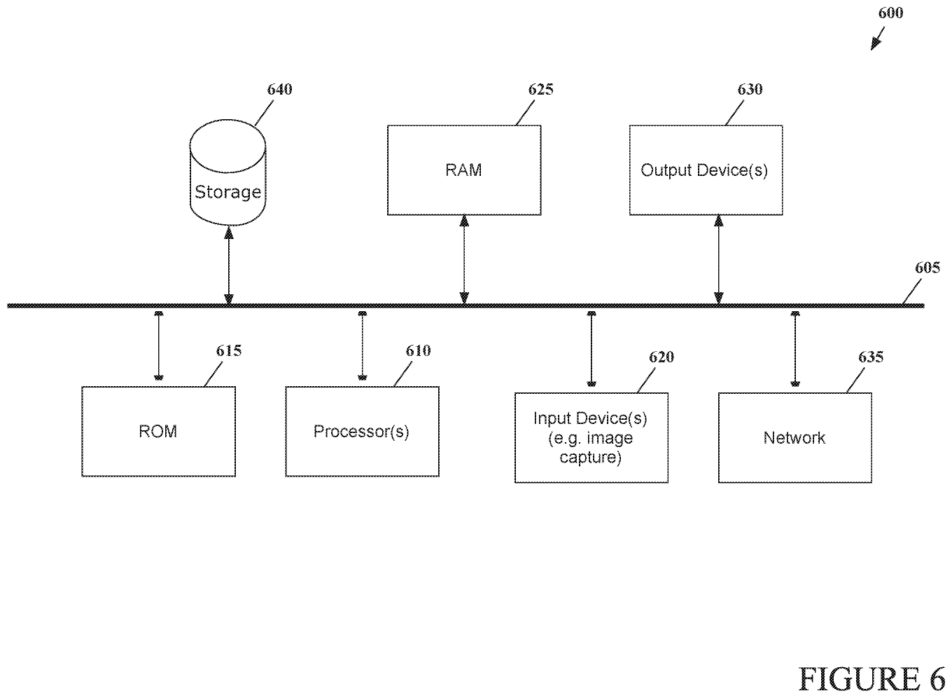

FIG. 6 illustrates an exemplary a system 600 that may implement the system. The electronic system 600 of some embodiments may be a mobile apparatus. The electronic system includes various types of machine-readable media and interfaces. The electronic system includes a bus 605, processor(s) 614, read only memory (ROM) 615, input device(s) 620, random access memory (RAM) 625, output device(s) 630, a network component 635, and a permanent storage device 640.

The bus 605 communicatively connects the internal devices and/or components of the electronic system. For instance, the bus 605 communicatively connects the processor(s) 610 with the ROM 615, the RAM 625, and the permanent storage 640. The processor(s) 610 retrieve instructions from the memory units to execute processes of the invention.

The processor(s) 610 may be implemented with one or more general-purpose and/or special-purpose processors. Examples include microprocessors, microcontrollers, DSP processors, and other circuitry that can execute software. Alternatively, or in addition to the one or more general-purpose and/or special-purpose processors, the processor may be implemented with dedicated hardware such as, by way of example, one or more FPGAs (Field Programmable Gate Array), PLDs (Programmable Logic Device), controllers, state machines, gated logic, discrete hardware components, or any other suitable circuitry, or any combination of circuits.

Many of the above-described features and applications are implemented as software processes of a computer programming product. The processes are specified as a set of instructions recorded on a machine-readable storage medium (also referred to as machine readable medium). When these instructions are executed by one or more of the processor(s) 610, they cause the processor(s) 610 to perform the actions indicated in the instructions.

Furthermore, software shall be construed broadly to mean instructions, data, or any combination thereof, whether referred to as software, firmware, middleware, microcode, hardware description language, or otherwise. The software may be stored or transmitted over as one or more instructions or code on a machine-readable medium. Machine-readable media include both computer storage media and communication media including any medium that facilitates transfer of a computer program from one place to another. A storage medium may be any available medium that can be accessed by the processor(s) 610. By way of example, and not limitation, such machine-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a processor. Also, any connection is properly termed a machine-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects machine-readable media may comprise non-transitory machine-readable media (e.g., tangible media). In addition, for other aspects machine-readable media may comprise transitory machine-readable media (e.g., a signal). Combinations of the above should also be included within the scope of machine-readable media.

Also, in some embodiments, multiple software inventions can be implemented as sub-parts of a larger program while remaining distinct software inventions. In some embodiments, multiple software inventions can also be implemented as separate programs. Any combination of separate programs that together implement a software invention described here is within the scope of the invention. In some embodiments, the software programs, when installed to operate on one or more electronic systems 600, define one or more specific machine implementations that execute and perform the operations of the software programs.

The ROM 615 stores static instructions needed by the processor(s) 610 and other components of the electronic system. The ROM may store the instructions necessary for the processor(s) 610 to execute the processes provided by the system. The permanent storage 640 is a non-volatile memory that stores instructions and data when the electronic system 600 is on or off. The permanent storage 640 is a read/write memory device, such as a hard disk or a flash drive. Storage media may be any available media that can be accessed by a computer. By way of example, the ROM could also be EEPROM, CD-ROM or other optical disk storage, magnetic disk storage or other magnetic storage devices, or any other medium that can be used to carry or store desired program code in the form of instructions or data structures and that can be accessed by a computer.

The RAM 625 is a volatile read/write memory. The RAM 625 stores instructions needed by the processor(s) 610 at runtime, the RAM 625 may also store the real-time video or still images acquired by the system. The bus 605 also connects input and output devices 620 and 630. The input devices enable the user to communicate information and select commands to the electronic system. The input devices 620 may be a keypad, image capture apparatus, or a touch screen display capable of receiving touch interactions. The output device(s) 630 display images generated by the electronic system. The output devices may include printers or display devices such as monitors.

The bus 605 also couples the electronic system to a network 635. The electronic system may be part of a local area network (LAN), a wide area network (WAN), the Internet, or an Intranet by using a network interface. The electronic system may also be a mobile apparatus that is connected to a mobile data network supplied by a wireless carrier. Such networks may include 3G, HSPA, EVDO, and/or LTE.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order and are not meant to be limited to the specific order or hierarchy presented.

The various aspects of this disclosure are provided to enable one of ordinary skill in the art to practice the present invention. Various modifications to exemplary embodiments presented throughout this disclosure will be readily apparent to those skilled in the art, and the concepts disclosed herein may be extended to other apparatuses, devices, or processes. Thus, the claims are not intended to be limited to the various aspects of this disclosure but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 18(f) unless the element is expressly recited using the phrase “means for” or, in the case of a method claim, the element is recited using the phrase “step for.”

Thus, an ID system has been described.

What is claimed is:

1. A method of providing user authentication comprising:
creating a Control Image of a User on a User device;
adding device identifying information to the User device;
storing the Control Image and device identifying information;
creating a Challenge Image of the User on the User device;
comparing the Challenge Image to the Control Image;
authenticating the User when the Challenge Image matches the Control Image.

2. The method of claim 1 further including the step of confirming the device using the device identifying information to authenticate the User.

3. The method of claim 1 wherein the Control Image is taken automatically by the User device when an app is invoked on the User device.

4. The method of claim 3 wherein the Challenge Image is taken automatically by the User device when the app is invoked on the User device.

5. The method of claim 4 wherein the app instructs the User on face orientation and position.

7. The method of claim 1 further including creating a Liveness Control Image of the User on the User device.

8. The method of claim 7 further including creating a Liveness Challenge Image of the User on the User device.

9. The method of claim 8 wherein the User is authenticated when the Liveness Challenge Image matches the Liveness Control Image.
